(19) United States
(12) Patent Application Publication
(10) Pub. No.: US 2002/0007131 A1
(43) Pub. Date: Jan. 17, 2002

(54) Healthy body ball

(76) Inventor: Cheryl E. Zemont, Tucson, AZ (US)

Correspondence Address: CHERYL E. ZEMONT, 3639 N. CAMINO CHRISTY, TUCSON, AZ, 85742, US

(21) Appl. No.: 09/905,741

(22) Filed: Jul. 12, 2001

Related U.S. Application Data
(60) Provisional application No. 60/218,249, filed on Jul. 14, 2000.

(51) Int. Cl. A61H 7/00

(52) U.S. Cl. 601/134

(57) ABSTRACT

The Healthy Body Ball is a multifunction device to aid trigger-point therapy. It is a spherical ball-shaped device with an array of pliable, radius-end nodes that project in an axial manner outward from the exterior surface of the ball. It can be manipulated by hand of the user or second person administrator. Effective manipulation to the user's back and neck are achieved with the device placed on a floor surface. The user applies supine body pressure on the device to roll it to an affected trigger-point location. The Healthy Body Ball, is a totally portable device, that can be self-administered or second-person administered to locate and reduce irritated trigger-points.

### BACKGROUND OF THE INVENTION

1. Field of the Invention

This invention relates to the field of massage therapy, specifically, to topical manipulation to determine the location of irritated trigger-points and with point-of-pressure applications to reduce the attendant pain.

2. Description of the Prior Art

There have been many massage therapy devices presented over the time of U.S. patent processing. There have been a limited number of these devices that have functional relationship to locating and applying trigger-point therapy. This is probably due to the relatively brief period of time that the trigger-point therapy protocol has been granted acceptance to the physical therapy field.

One example of a limited function massage ball device is disclosed in U.S. Pat. No. D. 419,681 issued to Chen. This design configuration device has an array of nodules affixed to the common plane of a hand-held platform. By design this device does not have a capability to locate and treat specific irritated trigger-points. As a hand-held device, it is also limited to a user's reachable personal body areas or would require second person assistance.

Another example is disclosed in U.S. Pat. No. 5,913,839 issued to Wincek. This device has an array of massage balls positioned and attached to a contoured base board. The fixed-position ball array limits the potential for locating and treating irritated trigger-points. Desirable manipulation is further limited with the user lying in a relatively fixed supine position on the device with the fixed-ball contact positions to the back and neck.

A limited example is also disclosed in U.S. Pat. No. D. 403,076 issued to York. This hand-held massage ball design configuration is limited by the fact that it is a hand-held device. As such, it is limited to reachable personal body areas or would require second person assistance. The relative size and hardness of the roller-ball configuration offers limited potential to locate and treat specific irritated trigger-points.

### SUMMARY OF INVENTION

Disadvantages inherent to known devices have been outlined. The need for this multipurpose device has been pronounced. The present invention has been developed with diligent consideration in engineering design and testing to satisfy these major function conditions:

1) Assist the process of trigger-point therapy with a spherically shaped ball having between 4 and 14 pliable, radius end nodes projecting axially from the outside diameter; 2) provide a device that can be self administered or second person administered over the known trigger-point areas of the body; 3) provide a spherically shaped device that is rotationally manipulated in a step-function manner to investigate and locate irritated trigger-points; 4) reduce trigger point pain with axially applied pressure through the pliable, radius end projections and into a subject trigger-point. The preferred embodiment is baseball or softball sized with from 12 to 14 pliable, radius-end nodes projecting axially from the outside diameter. It can be molded with a medium durometer rubberized material or fabricated with a plastic ball with axially positioned rubberized nodes.

### DRAWING DESCRIPTIONS

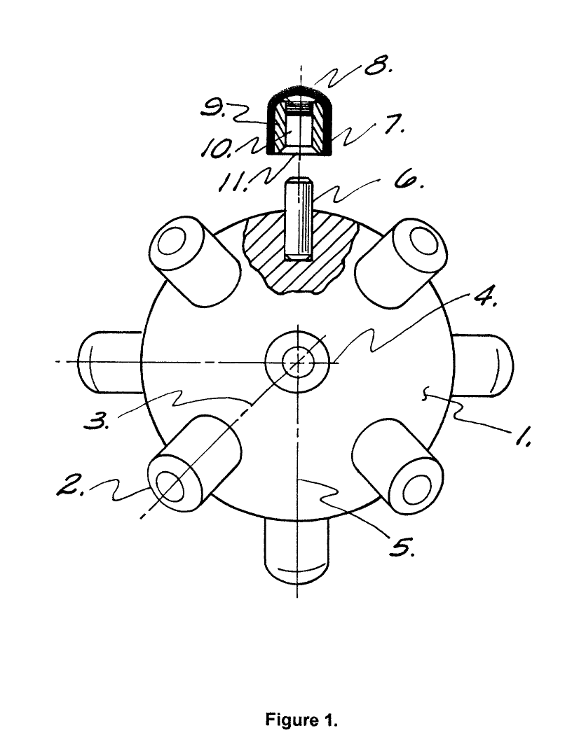

Drawing FIG. 1. This elevation view of the Healthy Body Ball provides the relationship of the basic ball (1) to the pliable, radius-end nodes (2) that project axially (3) from the centerline to the outside diameter of the ball. The nodes (2) are positioned along rotated latitudinal (4) and longitudinal (5) lines on the outside diameter surface. A fabricated structure option is displayed in the node at the top of FIG. 1. In this embodiment a pin (6) is press-fit to the ball at a node position. The node surface (7) has a radius (8) to allow pressure deflection of the internal rubberized material (9). A slip-fit hole (10) with countersink (11) is located on the centerline at the distal end of the node.

What is claimed is:

1. A unique trigger-point therapy device comprised of:
a spherical rubberized, plastic or composition ball;
a series of pliable, radius-end nodes projecting from the surface;
a unique potential for various node composition and pliability.

2. The combination Healthy Body Ball of claim 1, wherein the spherical shape allows rotational manipulation over any skin surface of a person.

3. The combination Healthy Body Ball of claim 1, wherein the rotational manipulation of the ball permits the axial-stationed node projections to locate irritated trigger-points.

4. The combination Healthy Body Ball of claim 1, wherein a pliable node at a station point can be applied with pressure to reduce associated pain.

5. The combination Healthy Body Ball of claim 1, wherein the portable device can be self-administered or second-person administered to all known trigger-point areas of the body.
